(19) United States
(12) Patent Application Publication
(10) Pub. No.: US 2016/0146202 A1
(43) Pub. Date: May 26, 2016

(54) OVERSHOOT REDUCTION ON PUMP CONTROLS

(71) Applicant: PARKER-HANNIFIN CORPORATION, Cleveland, OH (US)

(72) Inventors: Hao ZHANG, Twinsburg, OH (US); Lin WANG, Columbus, OH (US); Zhesheng JIANG, Solon, OH (US); Kyle MERRILL, Marysville, OH (US)

(21) Appl. No.: 14/905,124

(22) PCT Filed: Jul. 25, 2014
(86) PCT No.: PCT/US2014/048132

§ 371 Date: Jan. 14, 2016

Related U.S. Application Data
(60) Provisional application No. 61/859,836, filed on Jul. 30, 2013.

(51) Int. Cl. F04B 49/08; G05B 15/02; F04B 1/12; F04B 1/14; F04B 1/29

(52) U.S. Cl. CPC F04B 49/08; F04B 1/146; F04B 1/143; F04B 1/295; F04B 1/124; G05B 15/02

(57) ABSTRACT

Proposed is a method for controlling pressure supplied by a hydraulic pump that includes determining whether there is an impending overshoot in a value of the pressure supplied by the hydraulic pump and engaging a peak and hold controller when it is determined that there is an impending overshoot in a value of the pressure supplied by the hydraulic pump, thereby reducing or eliminating supplied pressure overshoot.

### FIELD OF INVENTION

The present invention relates generally to fluid pump control, and more particularly to a method and system for avoiding overshoot in fluid pump control.

### BACKGROUND

Pressurized fluid can be used to generate, control, and transmit power. FIG. 1 illustrates an exemplary fluid power system in the form of a hydraulic system 10 for providing hydraulic power to an actuator. The exemplary system 10 includes a prime mover 12, such as an internal combustion engine, electric motor, or the like, having an output shaft mechanically coupled to an input shaft of a hydraulic pump 14. A fluid inlet conduit 14a of the hydraulic pump 14 receives hydraulic fluid stored in reservoir 16, and provides the fluid to an actuator 18 (e.g., a hydraulic cylinder, hydraulic motor, etc.) via a fluid outlet conduit 14b. Upon exiting the actuator 18, the fluid is returned to the reservoir 16 via a return line conduit 18a.

In the illustrated embodiment the hydraulic pump 14 is a variable displacement hydraulic pump, whereby pump displacement can be varied via a rotatable swashplate 20. In this regard, a controller 22, such as a programmable logic controller or other processor-based controller, provides a signal to an actuator 24 coupled to the swashplate 20, the signal corresponding to an angular position of the swashplate 20. Based on the signal provided by the controller 22, the actuator 24 moves the swashplate 20 to a desired angle to produce a desired displacement per revolution of the pump 14.

In conventional systems, the controller 22 includes a PID controller for controlling fluid pressure within the fluid system 10. To enhance performance of such systems, gain scheduling may be used to vary a proportional gain of the system. FIG. 2 is a block diagram illustrating a conventional control system 30 that employs a PID controller and gain scheduling.

In FIG. 2 a pressure command signal 32 (e.g., a desired pressure within the system 10) is provided to a positive-end input of a summing junction 34, and an output of the summing junction 34, which is an error signal, is provided to a gain scheduler 36. The gain scheduler 36 selects a gain from a plurality of different gains based on a scheduling variable, which in the example of FIG. 2 is a flow feedback signal 38 (Q_Feedback). The selected gain then is applied to the error signal to produce a modified error signal, and this modified error signal is provided by the gain scheduler 36 to an input of PID controller 40. The PID controller 40 applies proportional, integral and derivative gains to the modified error signal to produce a control signal at an output of the PID controller 40. The PID control signal then is provided to the pump actuator 24 of the hydraulic pump 14, which positions the swashplate 20 based on the control signal so as to vary a displacement of the pump 14 and thus varying hydraulic pressure in the system 10. A pressure sensor 42 measures the pressure in the system 10 and provides the measured pressure 43 to a negative-end input of summing junction 34, thereby closing the loop.

FIG. 3 is an exemplary pressure response graph 50 showing a pressure command signal 32 and a pressure feedback signal 43 for the conventional system 10. When system pressure changes rapidly in conventional systems overshoot inevitably occurs. As can be seen in FIG. 3, significant pressure overshoot 52 is present. Such overshoot is due at least in part to the PID controller 40 not being able to efficiently provide a control signal that causes pressure feedback to follow pressure command. This overshoot can cause pump and/or system damage.

### SUMMARY OF INVENTION

A method and system in accordance with the present disclosure can reduce or even eliminate large pressure or torque overshoot imposed on fluid pumps. The system and method in accordance with the present disclosure can use predictive control to determine a feedforward term, which under certain conditions can be combined with the PID controller output or replace the PID controller output. One method in accordance with the present disclosure to reduce/eliminate pressure or torque overshoot is referred to as peak and hold.

According to one aspect of the invention, a method for controlling fluid pressure supplied by a fluid pump includes: determining whether there is an impending overshoot in fluid pressure supplied by the fluid pump; and engaging a peak and hold controller when it is determined that there is an impending overshoot in the fluid pressure supplied by the hydraulic pump, thereby reducing or eliminating fluid pressure overshoot.

According to one aspect of the invention, determining whether there is an impending overshoot includes concluding there is an impending overshoot when i) a flow provided by the fluid pump is greater than a predetermined percentage of full flow, ii) fluid pressure is greater than a predetermined percentage of a control command pressure, and iii) fluid pressure is continuously increasing over a predetermined time period.

According to one aspect of the invention, step iii) includes determining if feedback pressure is greater than previously sensed feedback pressures for a predetermined number of time steps, each time step having an associated respective one of the previously sensed control feedback pressures.

According to one aspect of the invention, the control command pressure is a desired pressure.

According to one aspect of the invention, the predetermined percentage of full flow is 75%.

According to one aspect of the invention, the predetermined percentage of control command pressure is 90%.

According to one aspect of the invention, engaging the peak and hold controller includes generating a fixed controller output signal.

According to one aspect of the invention, engaging the peak and hold controller includes holding the fixed controller output signal for a predetermined time period.

According to one aspect of the invention, the method includes disengaging the peak and hold controller and engaging the PID controller upon the predetermined time period expiring.

According to one aspect of the invention, the method includes determining the fixed value by predicting a future state of the pressure supplied by the fluid pump.

According to one aspect of the invention, determining the fixed value includes setting the fixed value equal to a value predicted to produce a desired pressure supplied by the fluid pump.

According to one aspect of the invention, engaging the peak and hold controller includes bypassing a PID controller.

According to one aspect of the invention, the controller output is a coil current for a fluid piston pump swashplate actuator.

According to one aspect of the invention, the method includes actuating a swashplate of a fluid piston pump at an angle corresponding to the desired output pressure of the fluid piston pump.

According to one aspect of the invention, the method includes holding the swashplate at the angle as the pressure supplied by the fluid pump rises to a desired output pressure.

According to one aspect of the invention, the method includes holding the swashplate at the angle for a predetermined time period after the desired output pressure is supplied by the fluid pump, thereby holding the output pressure of the fluid pump at the desired output pressure.

According to one aspect of the invention, engaging the peak and hold controller includes determining a feedforward term and combining the feedforward term with an output of a PID controller.

According to one aspect of the invention, determining whether there is an impending overshoot includes sensing a control feedback pressure.

According to one aspect of the invention, determining whether there is an impending overshoot includes comparing the control feedback pressure with a control command pressure.

According to one aspect of the invention, determining whether there is an impending overshoot includes comparing the control feedback pressure with a predetermined percentage of a control command pressure.

According to one aspect of the invention, a controller for controlling fluid pressure supplied by a fluid pump includes: a processor and memory; and logic stored in memory and executable by the processor, the logic including logic configured to cause the processor to execute the method described herein.

According to one aspect of the invention, a hydraulic system includes: a controller as described herein; and a fluid piston pump controlled by the controller.

The foregoing and other features of the invention are hereinafter described in greater detail with reference to the accompanying drawings.

### BRIEF DESCRIPTION OF THE DRAWINGS

FIG. 1 is a simple schematic diagram illustrating an exemplary hydraulic system to which the principles in accordance with the present disclosure can be applied.

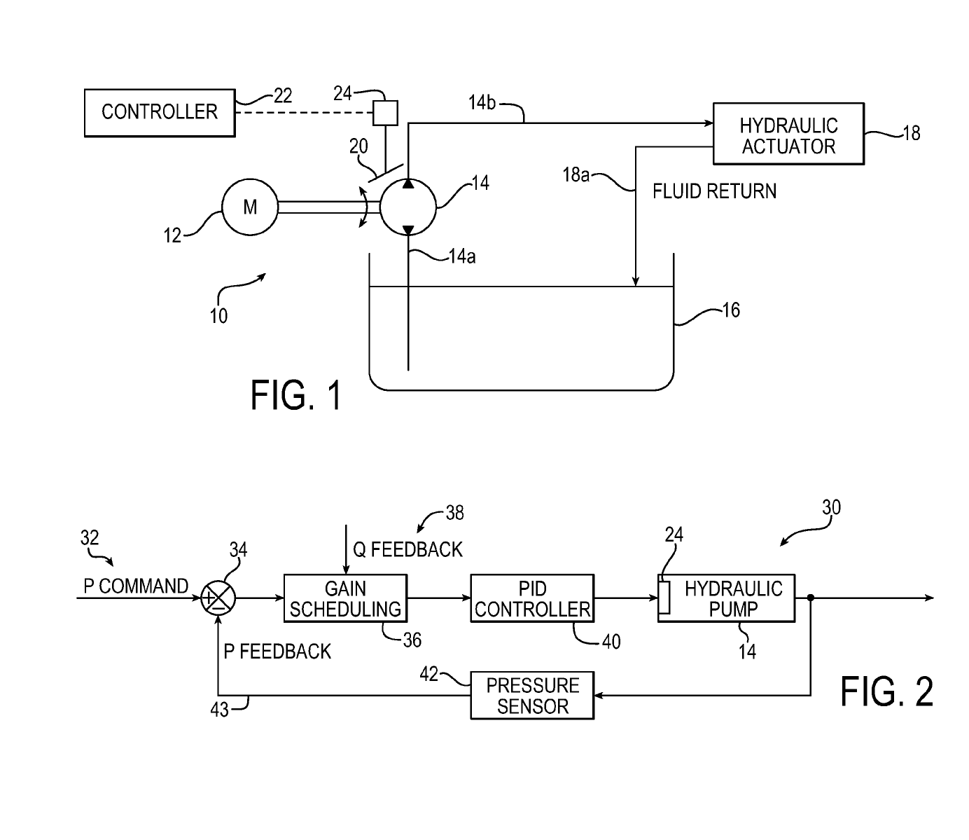

FIG. 2 is a block diagram illustrating a conventional pressure control block diagram.

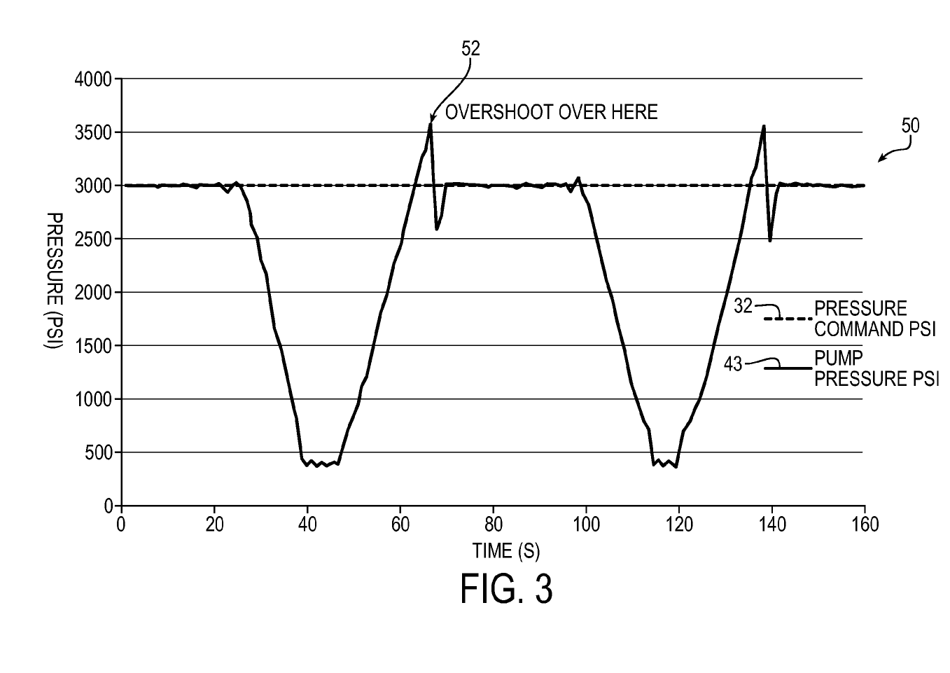

FIG. 3 illustrates pressure overshoot in the system of FIG. 1 when implementing the conventional control block diagram of FIG. 2.

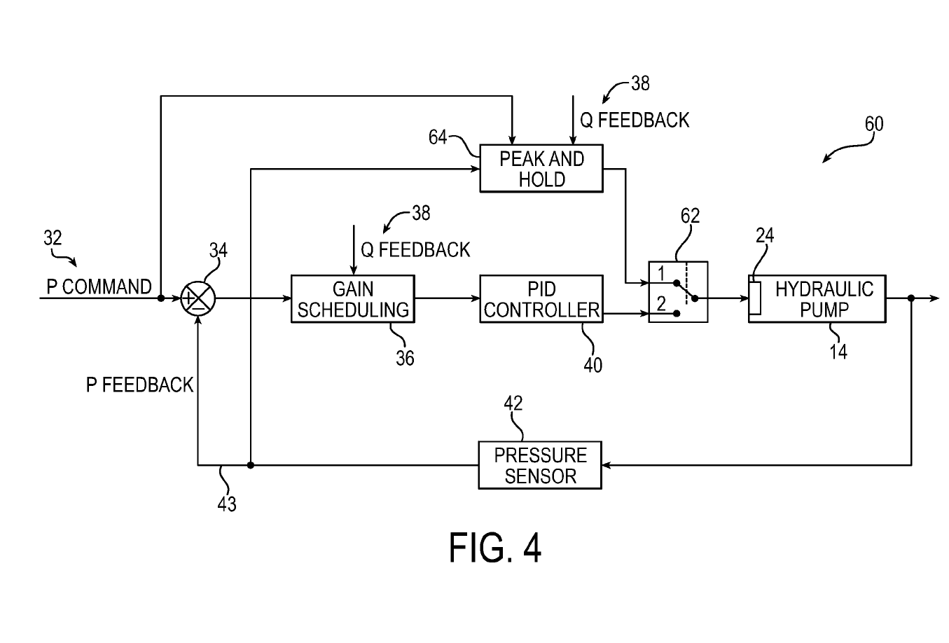

FIG. 4 is a block diagram illustrating an exemplary pressure control block diagram with peak and hold methodology in accordance with the present disclosure.

FIG. 5 illustrates reduced overshoot in the system of FIG. 1 when implementing the control block diagram of FIG. 4.

FIG. 6 is a flow chart providing a general steps for implementing a peak and hold control function in accordance with the present disclosure.

FIGS. 7A and 7B are flowcharts showing detailed steps for carrying out an exemplary peak and hold control function in accordance with the present disclosure.

### DETAILED DESCRIPTION

A system and method in accordance with the present disclosure will be described with reference to the drawings, where like reference numerals are used to refer to like elements throughout. It will be understood that the figures are not necessarily to scale.

It is noted that a methodology to reduce/eliminate torque overshoot is similar to a methodology to reduce/remove pressure overshoot. Therefore, in the subsequent disclosure only a pressure overshoot reduction/removal methodology will be discussed. One having ordinary skill in the art would understand that the principles discussed herein are applicable to both scenarios.

In a fluid system pressure overshoot can be expected to occur when pressure continues to increase while fluid flow out of the pump is greater than a prescribed value (e.g., 75% of full flow and/or 90% of pressure command). If the pressure overshoot is significant, a conventional PID controller may not be able to compensate for the increasing pressure, and in some instances may make the situation worse due to integral windup. In accordance with the present disclosure, a peak and hold controller/method is used to implement overshoot reduction/removal.

According to control theory, a future state of a control variable can be predicted based on an estimate of future states of a process variable. In this regard, a controller output can be estimated based on a current trend of the controlled variable. The estimated controller output then can take the place of the PID control output.

For example, in pump pressure control swashplate coil current may be estimated so that the controller output can move the swashplate of the hydraulic piston pump prior to the occurrence of an overshoot and, hence, avoid the occurrence of future pressure overshoot. A peak and hold controller/method in accordance with the present disclosure can carry out such predictive control. As used herein, a peak and hold controller/method is a controller/method that switches out a variable controller output for a fixed prescribed output (peak) for use with a controlled process, the switch to the fixed prescribed output being maintained for a prescribed time period (hold), and upon the prescribed time period elapsing releasing the fixed prescribed output.

The peak and hold controller/method in accordance with the present disclosure sets the controller output to an estimated value based on the controlled variable. In this regard, the peak and hold controller/method bypasses the conventional PID control and provides a feedforward term for output by the controller/method. When controlling a pump, the controller output may be in the form of coil current for a swashplate actuator, and such coil current may vary depending on different pressure ranges. In accordance with peak and hold controller/method, an estimated coil current is given directly to the swashplate actuator (the “peak”) so that the angle of the pump swashplate changes accordingly. This current output or swash angle should remain unchanged for some time (the “hold”). Both the “peak” and “hold” values are predicted by the algorithm or determined by testing. The swashplate coil current output should be selected such that there is little or no oscillation in system pressure. Preferably, the current is set to implement bumpless transfer from peak and hold to PID control.

The peak value output by the controller may be based calibration data obtained during system setup and/or calibration. Further, the peak and hold cycle can repeat for a number of times until the overshoot is removed or reduced to an acceptable level. In addition,

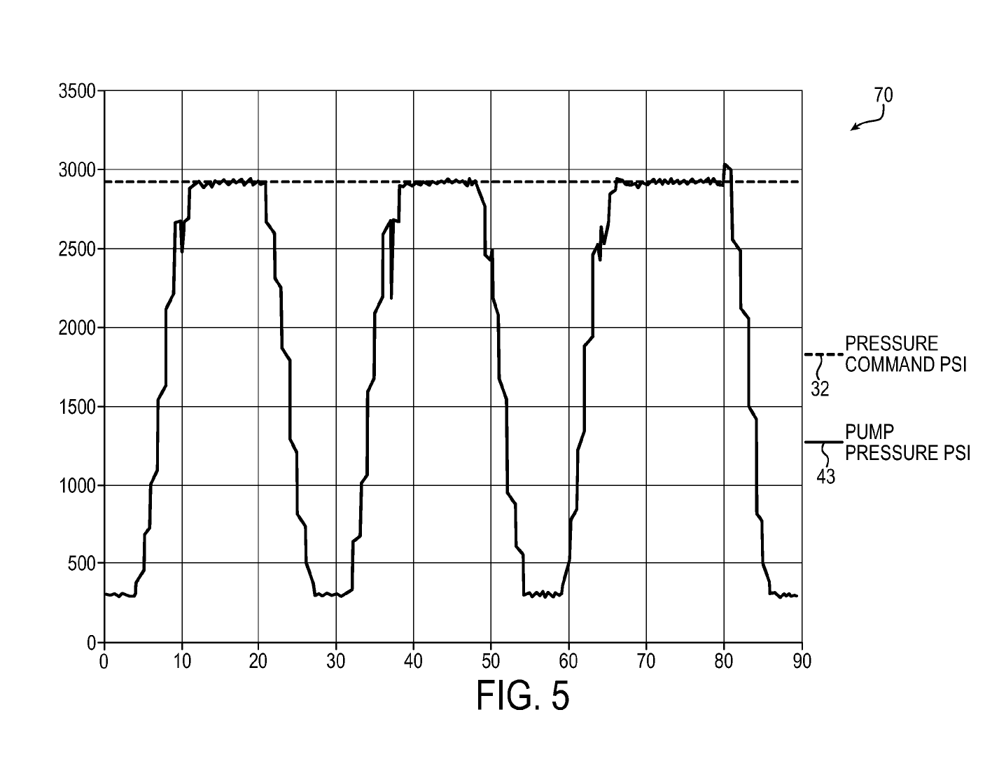

FIG. 4 illustrates a block diagram of an exemplary control methodology 60 implementing peak and hold control for reducing or eliminating large pressure overshoot. More particularly, a pressure command signal 32 is provided to a positive-end input of a summing junction 34, and an output of the summing junction 34 is provided to (optional) gain scheduler 36. The gain scheduler 36 selects a gain from a plurality of different gains based on a scheduling variable, which in the example of FIG. 4 is flow feedback 38 (Q_Feedback). Based on the error signal and flow feedback 38, different proportional gains for PID controller 40 are selected. The control signal from the PID controller 40 with the new proportional gain then is provided to a one input of a switch 62, and an output of the switch 62 is provided to the pump actuator 24 of the hydraulic pump 14. As discussed above, the actuator 24 positions the swashplate 20 based on the control signal so as to vary a displacement of the pump 14 and thus vary hydraulic pressure in the system 10. A pressure sensor 42 monitors the pressure in the system 10 and provides the measured pressure 43 to a negative-end input of summing junction 34.

A peak and hold controller 64 includes a first input connected to the positive-end input of the summing junction 34 (pressure command), a second input connected to the negative-end input of the summing junction 34 (pressure feedback), and a third input for receiving flow feedback 38. An output of the peak and hold controller 64 is connected to the other input of switch 62, the switch 62 being operative to select either the output from the PID controller 40 or the output from the peak and hold controller 64 as the control variable for the hydraulic pump 14.

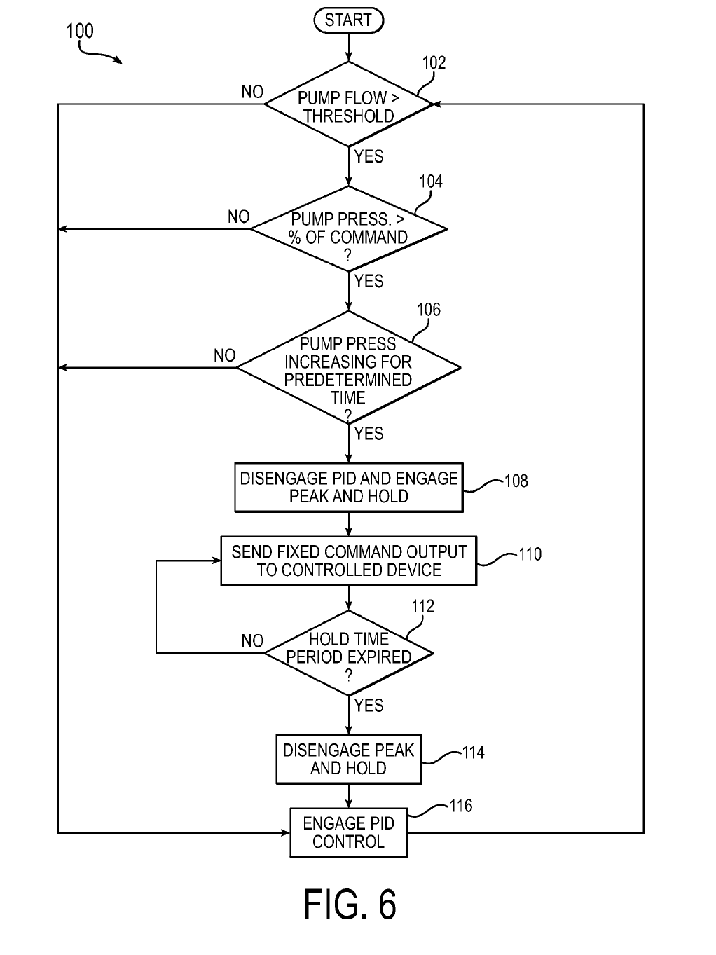

Referring to FIG. 5, a pressure response graph 70 is illustrated for system utilizing the peak and hold controller/method. More particularly, a pressure command signal 32 and a pressure feedback signal 43 are charted for a system using the peak and hold controller of FIG. 4. As can be seen, overshoot is dramatically reduced or even eliminated.

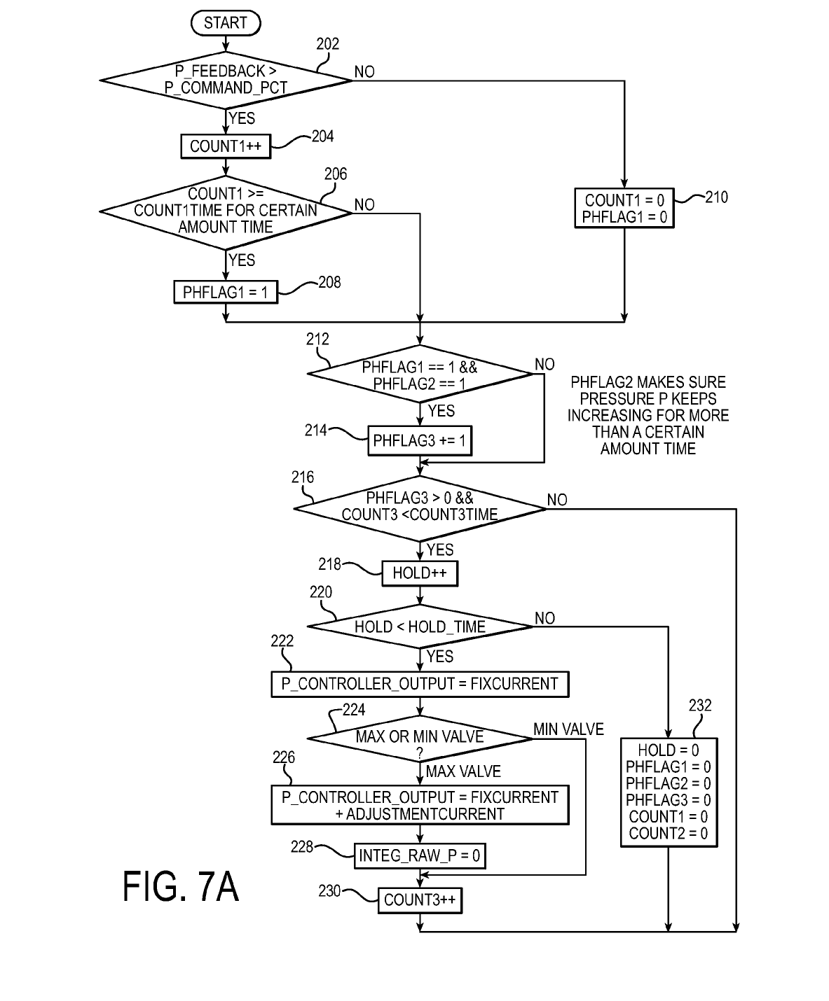

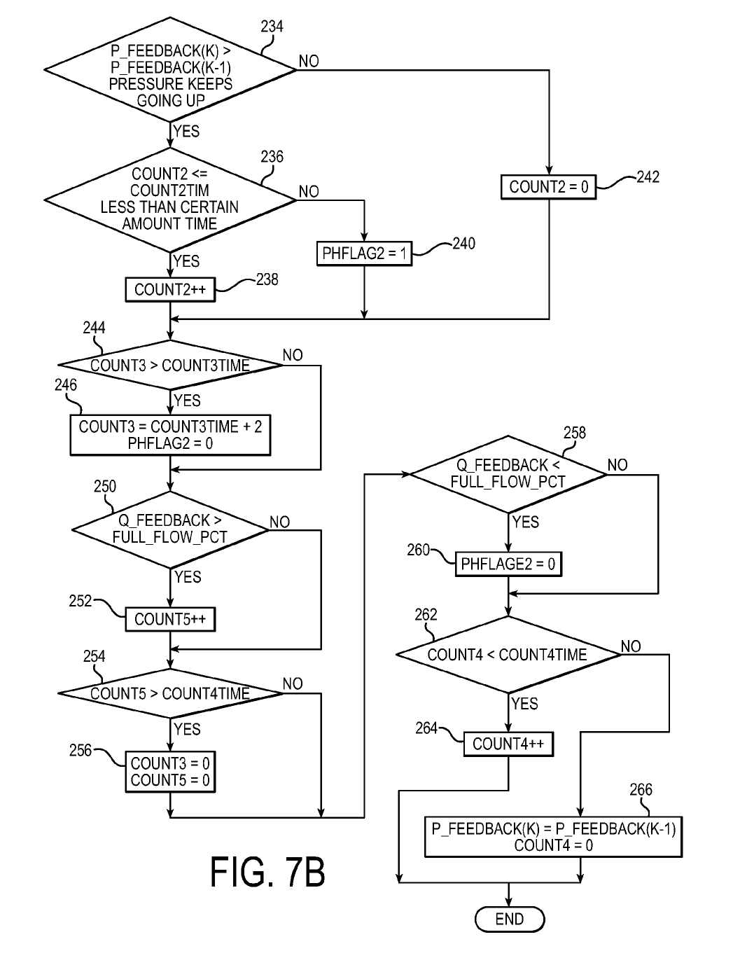

With additional reference to FIGS. 6, 7A and 7B, illustrated are flow diagrams illustrating exemplary steps for implementing a peak and hold control methodology in accordance with the present disclosure. The flow diagrams include a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Referring first to FIG. 6, a method 100 for controlling fluid pressure using a peak and hold methodology is illustrated. More particularly, in the method of FIG. 6 a determination is made whether there is an impending overshoot in fluid pressure supplied by a fluid pump. When it is determined that there is an impending overshoot in the fluid pressure, the peak and hold controller is engaged thereby reducing or eliminating fluid pressure overshoot.

Beginning at block 102, the fluid flow provided by the pump 14 is compared to a predetermined percentage of full flow rate of the pump 14 (rated pump flow). In one embodiment, the predetermined percentage of full flow rate is set to 75% of full (rated) flow of the pump 14. If the pump flow rate is not greater than the flow threshold, there is no impending overshoot and the method moves to block 116 where PID control is engaged. However, if the pump flow is greater than the flow threshold, the method moves to block 104 where the pump pressure (i.e., a pressure feedback, which may be sensed via pressure sensor 42) is compared to a percentage of the pressure control command (a percentage of pressure command 32). In one embodiment, the predetermined percentage of control command pressure is 90% of the command pressure.

If fluid pressure from the pump 14 is not greater than a predetermined percentage of the control command pressure, there is no impending overshoot and the method moves to block 116 where PID control is engaged. If the fluid pressure from the pump 14 is greater than the predetermined percentage of the control command pressure, then the method moves to block 106 to determine if fluid pressure is continuously increasing over a predetermined time period. In one embodiment, the predetermined time period is 5 milliseconds. For example, pressure can be said to be continuously increasing when a currently sensed feedback pressure is greater than previously sensed feedback pressures for a predetermined number of time steps, each time step having an associated respective one of the previously sensed control feedback pressures.

If the fluid pressure is not continuously increasing over the predetermined time period, there is no impending overshoot and the method moves to block 116 where PID control is engaged. However, if the fluid pressure is continuously increasing over the predetermined time period, it can be concluded that there is an impending overshoot and the method moves to block 108 where the PID controller 40 is disengaged (bypassed) and the peak and hold controller 64 is engaged.

For example, the switch 62 may be activated so as to decouple the input corresponding to the PID controller 40 from the switch output and couple the input corresponding to the peak and hold controller 64 to the switch output. Once engaged, the peak and hold controller 64 can generate a fixed controller output signal as indicated at block 110. The fixed value can be determined, for example, by predicting a future state of the pressure supplied by the fluid pump based on a particular controller output, and setting the output to correspond to the predicted pressure. In other words, the fixed value can be set equal to a value predicted to produce a desired pressure supplied by the fluid pump 14. The fixed controller output causes the actuator 24 to position the swashplate 20 at an angle corresponding to the desired output pressure of the pump.

At block 112 it is determined if a prescribed time delay for holding the fixed controller output signal has elapsed. If the time period has not elapsed, the method moves back to block 110, while if the time period has elapsed, the method moves to block 114. By holding the controller output to the prescribed fixed value the swashplate 20 is held at a fixed angle for the predetermined time period, thereby allowing the pressure supplied by the pump 14 to rise and be held at a desired output pressure. In one embodiment, the predetermined time period is 5 milliseconds. Upon the predetermined time period expiring, the peak and hold controller 64 is disengaged as indicated at block 114, and at block 116 the PID controller 40 is engaged. The method then moves back to block 102 and repeats.

Referring now to FIGS. 7A and 7B, flow diagrams are provided illustrating detailed steps for implementing an exemplary overshoot reduction in accordance with the present disclosure. FIGS. 7A and 7B include a number of flags, counters, variables and fixed values that will be briefly described here. More particularly, flags PHFlag1, PHFlag2, and PHFlag3 indicate the conditions at which the peak and hold algorithm is triggered for the first time (PHFlag1), is terminated or broken (PHFlag2), and is re-triggered (PHFlag3). Additionally, the flag “Hold” determines if the “hold” time (specified by the constant “Hold_Time”) has elapsed. FIGS. 7A and 7B also include five counters (Count1, Count2, Count3, Count4, and Count 5) that take advantage of four constants that provide upper limits, respectively. The four constants are Count1Time, Count2Time, Count3Time, and Count4Time, which may be set to correspond to predetermined time periods during system setup. The five counters dictate when the flags (PHFlag1, PHFlag2, PHFlag3) are set to 1 or a non-zero value and when the flags are reset to 0.

In addition, the variable P_Feedback represents pressure feedback in the system 10, the variable P_Command_Pct represents a percentage of pressure command, and the variables P_Feedback(k) and P_Feedback(k−1) represent the current measured pressure feedback and the previously measured pressure feedback, respectively. The variable Fix_Current is a predetermined value which may be predicted by the algorithm or determined by testing, while the variable Adjustment_Current is a value provided by a manufacturer of the actuator 24. The variable Integ_raw_p represents a raw integral output for pressure control loop. The peak and hold algorithm also utilizes pump flow information that is denominated by the variable Q_Feedback. To determine the values of Count3, Count4, and Count5, a flow threshold of Q_Feedback is set by Full_Flow_Pct.

Moving now to FIG. 7A, blocks 202-210 correspond to block 104 of FIG. 6. At block 202 the variable P_Feedback (pressure feedback) is compared to the variable P_Command_Pct (a percentage of pressure command), and if P_Feedback is not greater than P_Command_Pct, the method moves to block 210 where the variable Count1 and the flag PHFlag1 are set to 0. Moving back to block 202, if P_Feedback is greater than P_Command_Pct, then the method moves to block 204 where the variable Count1 is incremented, and at block 206 Count1 is compared to the variable Count1Time. If Count1 is greater than or equal to Count1Time for a predetermined amount of time, then this indicates pressure has been continuously rising for a predetermined time period and the method moves to block 208 where the flag PHFlag1 is set to 1 and moves to block 212. Moving back to block 206, if Count1 is not greater than or equal to Count1Time, this indicates pressure has not been continuously rising for a predetermined amount of time and the method skips block 208 and moves to block 212.

At block 212 an AND function is performed using the flags PHFlag1 and PHFlag2. More particularly, if both PHFlag1 and PHFlag2 are equal to 1, then the method moves to block 214 where the flag PHFlag3 is set to a non-zero value (e.g., PHFlag3 may be set to a value greater than 1) and the method moves to block 216. Moving back to block 212, if either PHFlag1 or PHFlag2 is not equal to 1, the method skips block 214 and moves to block 216.

Blocks 216-232 correspond to blocks 108-112 of FIG. 6. At block 216, if the flag PHFlag3 is not set to 0 or the variable Count3 is not less than the variable Count3Time, the method skips blocks 218-230 and moves to block 234, which is discussed below. However, if PHFlag3 is set to 0 and Count3 is less than Count3Time, the method moves to block 218 where the variable Hold is incremented, and at block 220 the value stored in the variable Hold is compared to the constant Hold_Time. If the value stored in Hold is not less than the value stored in Hold_Time, the method moves to block 232 where the flags and counters are reset. Specifically, the flags Hold, PHFlag1, PHFlag2 and PHFlag3 and the counters Count1 and Count 2 are all set to 0. The method then moves to block 234, which is discussed below. However, if the value stored in the variable Hold is less than the value stored in the constant Hold_Time, then the method moves to block 222 where the variable P_Controller_Output is set to the variable FixCurrent.

Next at block 224 it is determined if a Max valve or Min valve configuration is present in the system. Max valve and Min valve refer to two different types of control valves on the side of the pump. The max valve defaults the pump to maximum pump flow when no current is sent through the coils, while the min valve defaults the pump to minimum flow when no current is sent through the coils. During normal operation increasing current will either increase pump flow or decrease pump flow depending on the type of valve. Depending on the application, it may be desired that the pump go to minimum flow if power is lost, and in some applications it may be desired that the pump go to maximum flow if power is lost. If a Max valve configuration is present, then the method moves to block 226 where the variable P_Controller_Output is set to the sum of the variable FixCurrent and the variable AdjustmentCurrent and then moves to block 228. However, if at block 224 a Min valve configuration is present, the method bypasses block 226 and moves directly to block 228 where the variable Integ_raw_p is set to 0, and at block 230 the variable Count3 is incremented. If the flow or the percentage of spool stroke for a proportional directional control valve is directly proportional to the coil current, it is a min valve. If the flow or the percentage of spool stroke for a proportional directional control valve is inversely proportional to the coil current, otherwise, it is then a max valve.

Blocks 234-242 correspond to block 106 in FIG. 6. More particularly, at block 234 the variable P_Feedback(k) is compared to the previous version of P_Feedback(k−1) to determine if pressure is rising. If P_Feedback(k) is not greater than P_Feedback(k−1), then pressure is not continuously rising and at block 242 the variable Count 2 is set to 0 and the method moves to block 244. However, if P_Feedback(k) is greater than P_Feedback(k−1), then pressure is rising and at block 236 the variable Count2 is compared to Count2Time to determine if pressure has been continuously rising over a predetermined time period. If Count2 is less than or equal to Count2Time, then the time period has not elapsed and the method moves to block 238 where the value of Count2 is incremented, and then the method moves to block 244. However, if at block 236 Count2 is not less than or equal to Count2Time, then pressure has been continuously rising for a predetermined time period and the method moves to block 240 where PHFlag2 is set to 1. The method then moves to block 244.

At block 244, the variable Count3 is compared to the constant Count3Time. If Count3 is greater than Count3Time, the method moves to block 246 where Count3 is set to Count3Time plus 2, and PHFlag2 is set to 0. Moving back to block 244, if Count3 is not greater than Count3Time, then block 246 is skipped and the method moves to block 250

Blocks 250-260 correspond to block 102 of FIG. 6. At block 250 the variable Q_Feedback (i.e., flow feedback) is compared to the variable Full_Flow_Pct (a percentage of rated pump flow). If Q_Feedback is greater than Full_Flow_Pct, then the method moves to block 252 where the variable Count5 is incremented, and then the method moves to block 254. Moving back to block 250, if Q_Feedback is not greater than Full_Flow_Pct, then the method skips block 252 and proceeds to block 254.

At block 254 the variable Count5 is compared to the variable Count4Time. If Count5 is greater than Count4Time, the method moves to block 256 where the variables Count3 and Count5 are set to 0, and then the method proceeds to block 258. Moving back to block 254, if Count5 is not greater than Count4Time, then the method bypasses block 256 and moves to block 258.

At block 258, Q_Feedback is compared to Full_Flow_Pct, and if Q_Feedback is less than Full_Flow_Pct the method moves to block 260 where the flag PHFlag2 is set to 0, and the method proceeds to block 262. If at block 258 Q_Feedback is not less than Full_Flow_Pct, then the method bypasses block 260 and moves to block 262.

At block 262, the variable Count4 is compared to the variable Count4Time, and if Count4 is less than Count4Time the method moves to block 264 where Count4 is incremented. If, however, at block 262 Count4 is not less than Count4Time then the method moves to block 266 where and P_Feedback(k) is set to P_Feedback(k−1) and Count4 is set to 0. A purpose of block 266 is to filter noise from the measured pressure. Upon completion of blocks 264 or 266, the method moves back to block 202 and repeats.

The peak and hold controller/methodology in accordance with the present disclosure provides improved response relative to conventional PID controllers. Further, since the algorithm can be implemented within a controller, retrofit of existing systems to such peak and hold functionality can be easily implemented.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method for controlling fluid pressure supplied by a fluid pump, the method comprising:
determining whether there is an impending overshoot in fluid pressure supplied by the fluid pump; and
engaging a peak and hold controller when it is determined that there is an impending overshoot in the fluid pressure supplied by the hydraulic pump, thereby reducing or eliminating fluid pressure overshoot.

2. The method according to claim 1, wherein determining whether there is an impending overshoot includes concluding there is an impending overshoot when
i) a flow provided by the fluid pump is greater than a predetermined percentage of full flow,
ii) fluid pressure is greater than a predetermined percentage of a control command pressure, and
iii) fluid pressure is continuously increasing over a predetermined time period.

3. The method according to claim 2, wherein step iii) includes determining if feedback pressure is greater than previously sensed feedback pressures for a predetermined number of time steps, each time step having an associated respective one of the previously sensed control feedback pressures.

4. The method according to claim 2, wherein the control command pressure is a desired pressure.

5. The method according to claim 2, wherein the predetermined percentage of full flow is 75%.

6. The method according to claim 2, wherein the predetermined percentage of control command pressure is 90%.

7. The method according to claim 1, wherein engaging the peak and hold controller includes generating a fixed controller output signal.

8. The method according to claim 7, wherein engaging the peak and hold controller includes holding the fixed controller output signal for a predetermined time period.

9. The method according to claim 8, comprising disengaging the peak and hold controller and engaging the PID controller upon the predetermined time period expiring.

10. The method according to claim 2, further comprising determining the fixed value by predicting a future state of the pressure supplied by the fluid pump.

11. The method according to claim 10, wherein determining the fixed value includes setting the fixed value equal to a value predicted to produce a desired pressure supplied by the fluid pump.

12. The method according to claim 1, wherein engaging the peak and hold controller includes bypassing a PID controller.

13. The method according to claim 1, wherein the controller output is a coil current for a fluid piston pump swashplate actuator.

14. The method according to claim 1, further comprising actuating a swashplate of a fluid piston pump at an angle corresponding to the desired output pressure of the fluid piston pump.

15. The method according to claim 14, further comprising holding the swashplate at the angle as the pressure supplied by the fluid pump rises to a desired output pressure.

16. The method according to claim 15, further comprising holding the swashplate at the angle for a predetermined time period after the desired output pressure is supplied by the fluid pump, thereby holding the output pressure of the fluid pump at the desired output pressure.

17. The method according to claim 1, wherein engaging the peak and hold controller includes determining a feedforward term and combining the feedforward term with an output of a PID controller.

18. The method according to claim 1, wherein determining whether there is an impending overshoot includes sensing a control feedback pressure.

19. The method according to claim 18, wherein determining whether there is an impending overshoot includes comparing the control feedback pressure with a control command pressure.

20. The method according to claim 18, wherein determining whether there is an impending overshoot includes comparing the control feedback pressure with a predetermined percentage of a control command pressure.

21. A controller for controlling fluid pressure supplied by a fluid pump, the controller comprising:
a processor and memory; and
logic stored in memory and executable by the processor, the logic including logic configured to cause the processor to execute the method according to claim 1.

22. A hydraulic system comprising:
a controller according to claim 21; and
a fluid piston pump controlled by the controller.
